(19) United States
(12) Patent Application Publication
(10) Pub. No.: US 2003/0181216 A1
(43) Pub. Date: Sep. 25, 2003

(54) System and method for mobile station to handle resource collision between tasks

(75) Inventors: Hsien-Ming Tsai, Tainan (TW); Shang-Lin Chou, Taipei (TW); Jammy Huang, Taipei (TW)

Correspondence Address: LOWE HAUPTMAN GOPSTEIN GILMAN & BERNER, LLP, Suite 310, 1700 Diagonal Road, Alexandria, VA, 22314, US

(73) Assignee: QUANTA COMPUTER INC.

(21) Appl. No.: 10/252,435

(22) Filed: Sep. 24, 2002

(30) Foreign Application Priority Data
Mar. 20, 2002 (TW) 91105312

(51) Int. Cl. H04Q 7/20

(52) U.S. Cl. 455/517; 455/445

(57) ABSTRACT

When a mobile station stands by on multiple mobile networks simultaneously, the radio transceiver of the mobile station must be used to perform paging reception, location registration, carrier measurement, or broadcast reception for multiple mobile networks, respectively. However, a mobile station has one radio transceiver only and the multiple mobile networks don't negotiate with each other. Thus, resource collision occurs when the radio transceiver performs tasks for multiple mobile networks simultaneously. In order to handle resource collision, a priority task is determined and non-priority tasks are postponed or cancelled according to the mobile network distinction mainly and the task class subsequently.

### BACKGROUND OF THE INVENTION

1. Field of Invention

The present invention relates to a Cellular System. More particularly, the present invention relates to a system and method for a mobile station, which simultaneously stands by on multiple mobile networks to handle resource collision between tasks.

2. Description of Related Art

In the past, a mobile station had only one directory number of a mobile network so that the mobile station was limited to access mobile services from a single mobile network. If a mobile station has several directory numbers from multiple mobile networks (where the mobile station is referred to as a multi-directory mobile station), it would satisfy the following demands of users: 1. Calls can be divided into business calls and personal calls by public directory numbers and private directory numbers; 2. Callers can be distinguished into different groups by callee directory numbers; 3. Signal quality, fee rates and services of different mobile network service providers can be chosen flexibly; 4. New directory numbers and old directory numbers can be used simultaneously for number portability. Thus, a multi-directory mobile station is much more convenient for users.

In cellular systems (such as the Global System for Mobile communication, GSM), a directory number is associated with a mobile station by means of the Subscriber Identity Module (SIM) card. The SIM card is issued by the mobile network service provider which the mobile station user subscribes mobile services from. When the user inserts the SIM card into the SIM slot of his/her mobile station, the mobile station has a directory number so as to access mobile services form the mobile network. Nowadays, one SIM card is capable of having two directory numbers (as shown in FIG. 1(a)). However, this kind of SIM cards is issued by a single service provider. Under the restriction on SIM card issuing, the two directory numbers in a SIM card are belonging to the same service provider so that the mobile station user can't flexibly select signal quality, fee rates and mobile network services of different service providers. In order to access services from multiple mobile networks, the multi-directory mobile station should support multiple SIM cards (as shown in FIG. 1(b)).

In the market, there are two kinds of multi-directory mobile stations supporting multiple SIM cards: one is the mobile station with multiple slots for SIM cards, and the other is the mobile station having the battery with multiple slots for SIM cards. When any one of these mobile stations is powered on, its user can select one of multiple directory numbers to enable the corresponding one of multiple SIM cards for the selected mobile network services. Nevertheless, these two multi-directory devices have the common disadvantage: only one of multiple SIM cards can be enabled so that the mobile station can stand by on only one mobile network. (Standby is the state that a mobile station is powered on and awaiting for incoming calls). Moreover, if the other SIM card would like to be enabled, the mobile station must be turned off then back on to switch SIM cards. It is very inconvenient to execute these operations. Therefore, these two multi-directory mobile stations supporting multiple SIM cards can't simultaneously stand by on multiple mobile networks. This can not satisfy the demands for accessing different mobile network services simultaneously.

### SUMMARY OF THE INVENTION

When a mobile station with single directory number stands by on a mobile network, the radio transceiver is used to perform task classes comprising paging reception, location registration, broadcast reception, or carrier measurement. Paging reception is executed at paging occasions to confirm whether there is a call termination. Location registration is executed to inform the mobile network of present location area of the mobile station while it is moved with user. Broadcast reception is executed to receive the system information on Broadcast Control Channel from the mobile network. Carrier measurement is executed to search for a better cell and camp on it for maintaining radio signal quality. Tasks mentioned above are described with reference to GSM specifications 04.64, 05.02 and 05.08.

However, when a multi-directory mobile station simultaneously stands by on multiple mobile networks, the mobile station must perform the tasks mentioned above for all these mobile networks. Because a mobile station is used to have only one radio transceiver and the various mobile networks don't negotiate with one another, resource collision occurs when the radio transceiver performs the above tasks for multiple mobile networks simultaneously.

In order to solve the problem of resource collision, the present invention provides a method for a mobile station to handle resource collision between tasks. The present invention decides the priority of tasks, allocates resources to the high-priority task, and delays or cancels low-priority tasks. The task priority is decided according to the mobile network distinction mainly and according to the task class subsequently. The mobile network distinction of a task indicates that the task is executed for the corresponding mobile network. In cellular systems, the mobile network distinction can be a directory number (such as 0953405980 and 0912345678) or a mobile network reference number (such as 0953 or 0912). A SIM card reference number (such as 101 and 202 shown in FIG. 1(b)) can be one kind of mobile network distinction. In principle, mobile network distinction is used for recognizing the mobile network that the task performs for; hence, its format is not limited.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1(a) illustrates a mobile station having a single SIM card with two directory numbers in a single slot according to the prior art;

FIG. 1(b) illustrates a mobile station in which two SIM cards with individual directory numbers are inserted in double SIM slots respectively according to one preferred embodiment of the invention;

FIG. 2 illustrates a mobile communication system with two mobile networks according to one preferred embodiment of the invention;

FIG. 3 is a flowchart illustrating a mobile station system capable of handling resource collision between tasks according to the present invention;

FIG. 4 illustrates one preferred embodiment of the invention according to the mobile network distinction;

FIG. 5 illustrates another preferred embodiment of the invention according to the mobile network distinction; and

FIG. 6 illustrates one preferred embodiment of the invention according to the mobile network distinction and task classes.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

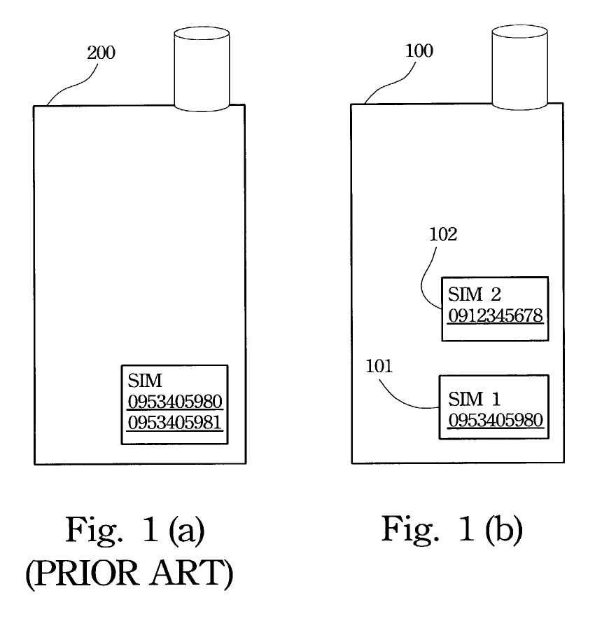

In one preferred embodiment of the invention, a mobile station, comprising a Radio Transceiver, two SIM cards and two directory numbers, can simultaneously stands by on double mobile networks. FIG. 1(b) illustrates a mobile station in which two SIM cards with individual directory numbers are inserted in double SIM slots respectively according to one preferred embodiment of the invention. A mobile station 100 comprises two SIM cards, for example, a SIM card 101 recording the identification information of the directory number: 0953405980, and a SIM card 102 recording the identification information of the directory number: 0912345678. The mobile station 100 can access the service of mobile network 0953 by the identification information of the SIM card 101. Also, the mobile station 100 can access the service of mobile network 0912 by the identification information of the SIM card 102. Thus, the mobile station 100 can access the services of two mobile networks by the identification information of two directory numbers.

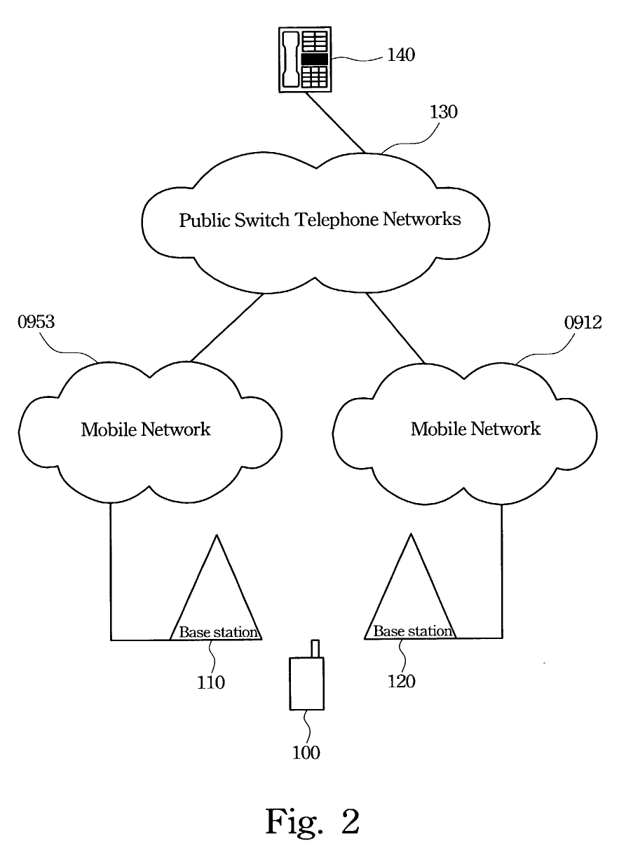

FIG. 2 illustrates a mobile communication system with two mobile networks according to one preferred embodiment of the invention. The mobile station 100 can receive radio signals from a base station 110 and a base station 120. The base station 110 belongs to the mobile network of 0953 (such as Taiwan Telecom GSM network). The base station 120 belongs to the mobile network of 0912 (such as Chunghwa Telecom GSM network). The mobile network of 0953 and the mobile network of 0912 both connect to Public Switch Telephone Networks (PSTN) 130. Thus, the mobile station 100 can connect to phone 140 via base stations, mobile networks and the PSTN. It is noted that the mobile network of 0953 and the mobile network of 0912 operate independently.

For the sake of clarity, a task in the mobile station is referred to in the following format: task number (starting time, ending time, mobile network distinction, task class). For example, task 1 (t_{1B}, t_{1E}, 0953, paging reception) means that the mobile station of the invention will perform task 1 for paging reception to the mobile network of 0953 in the execution interval, from starting time t_{1B} to ending time t_{1E}. The definition of resource collision is that the execution interval of one task overlaps with that of another task and these tasks use the same resource. For example, a Radio Transceiver is used to perform task 1 (t_{1B}, t_{1E}, 0953, paging reception) and task 2 (t_{2B}, t_{2E}, 0912, paging reception). If the execution interval of task 1 (i.e., from t_{1B} to t_{1E}) and the execution interval of task 2 (i.e., from t_{2B} to t_{2E}) overlap, resource collision occurs between task 1 and task 2.

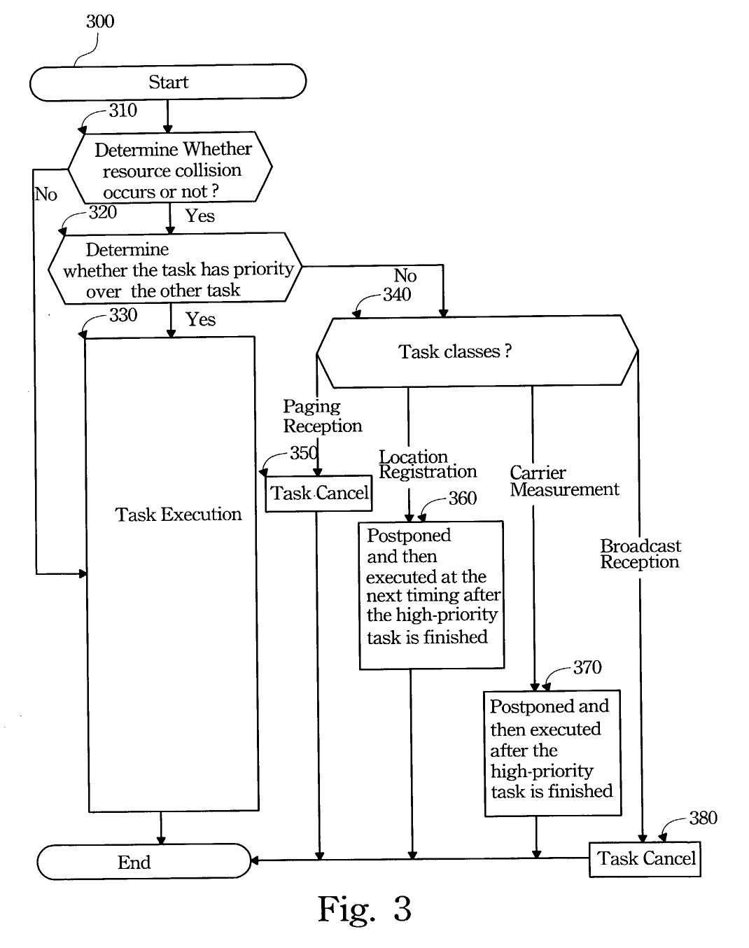

FIG. 3 is a flowchart illustrating a mobile station system capable of handling resource collision between tasks according to the present invention. First, a task is started (as indicated in step 300). Next, determine whether resource collision occurs or not (as in step 310). If collision doesn't occur, the task can be executed (as in step 330). If collision occurs, determine whether the task has the highest priority among all collided tasks (as shown in step 320). As mentioned above, in the mobile station according to the present invention, the priority of the task is decided based on mobile network distinction mainly and task classes subsequently. If the task has the highest priority, the task can be executed (as in step 330). If the task doesn't have the highest priority, the task can be delayed or canceled according to its task class (step 340-step 380).

Since task classes have different execution timing and different deadlines, a task can be delayed or canceled based on its task class (as in step 340). Among all task classes during standby state in a mobile station, paging reception is a real time task because the timing of paging reception is fixed and the deadline of paging response is urgent. If paging reception is delayed, Paging Loss may occur and an incoming call may be missed. To avoid the incoming call miss, the mobile station of the present invention can accommodate to the repaging mechanism supported by the mobile network. Repaging is executed if the mobile network can not receive the paging response form the paged mobile station. By repaging, paging reception at this timing can be canceled and executed again at the next timing (as indicated in step 350). In other task classes (such as location registration, carrier measurement and broadcast reception), they have more flexible execution timing and more loose deadlines than paging reception. Hence, the operation of mobile station may not be seriously influenced if these tasks are delayed. Location registration can be postponed and then executed at the next timing after the high-priority task is finished (as in step 360). Carrier measurement can be postponed and then executed after the high-priority task is finished (as in step 370) and then executed again. Because mobile networks broadcast messages repeatedly and usually, broadcast reception can be canceled (as in step 380).

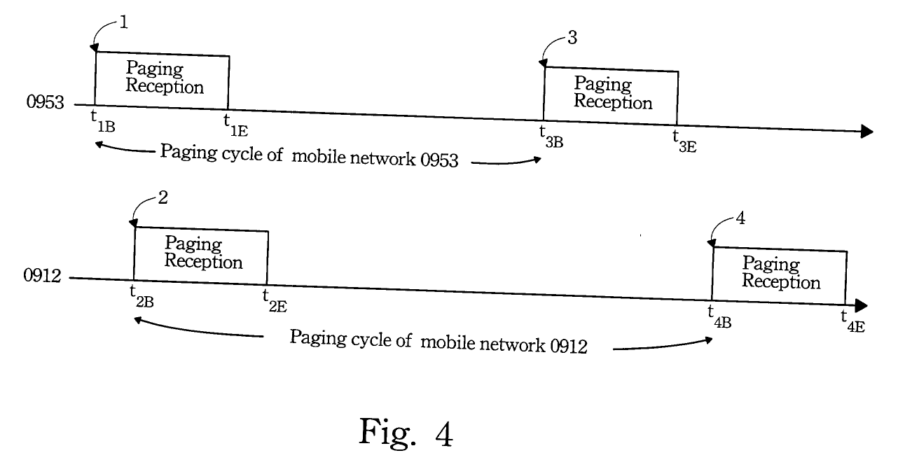

As shown in FIGS. 4-6, three preferred embodiments are illustrated to describe the present invention. In these preferred embodiments, a mobile station with two directory numbers (one is 0953405980, and the other is 0912345678) stands by on two mobile networks (mobile network 0953 and mobile network 0912) simultaneously. FIG. 4 illustrates one preferred embodiment of the invention. In this preferred embodiment, the tasks for mobile network 0912 have higher priority than those for mobile network 0953 and the task classes of two collided tasks are the same. As shown in FIG. 4, there are 4 predetermined tasks executed sequentially in this period of time:

Task 1 (t_{1B}, t_{1E}, 0953, paging reception)

Task 2 (t_{2B}, t_{2E}, 0912, paging reception)

Task 3 (t_{3B}, t_{3E}, 0953, paging reception)

Task 4 (t_{4B}, t_{4E}, 0912, paging reception)

For the sake of clarity, tasks for mobile network 0953 are labeled on the time axis of 0953 and tasks for mobile network 0912 are labeled on the time axis of 0912. Thus, Tasks 1, 3 are on the time axis of 0953 and Tasks 2, 4 are on the time axis of 0912. According to the flowchart illustrating a mobile station system to handle resource collision between tasks (as shown in FIG. 3), the mobile station determines whether resource collision occurs or not (as indicated in step 310) when task 1 begins. Obviously, resource collision occurs between task 1 and task 2 (i.e., execution intervals of two tasks overlap). Then, the mobile station determines whether task 1 has higher priority than task 2 or not (as in step 320). However, task 2 for mobile network 0912 has higher priority than task 1 so that task 2 is executed. On the other hand, since the task class of task 1 is paging reception, task 1 is canceled. After one paging cycle of mobile network 0953, the mobile station starts the paging reception (i.e., task 3) for repaging.

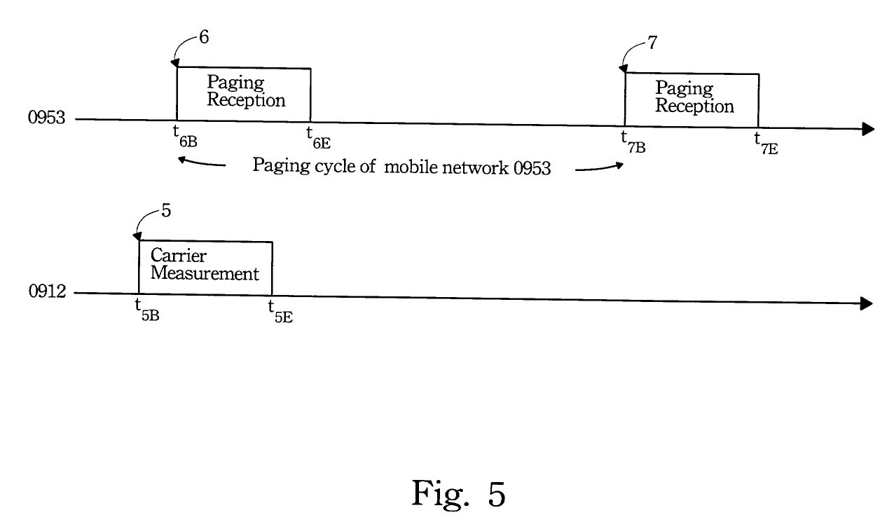

FIG. 5 illustrates one preferred embodiment of the invention. In this preferred embodiment of the invention, the tasks for mobile network 0912 have higher priority than those for mobile network 0953 and the task classes of two collided tasks are different. As shown in FIG. 5, there are 3 predetermined tasks executed sequentially in this period of time:

Task 5 (t_{5B}, t_{5E}, 0912, carrier measurement)

Task 6 (t_{6B}, t_{6E}, 0953, paging reception)

Task 7 (t_{7B}, t_{7E}, 0953, paging reception)

According to the flowchart illustrating a mobile station system to handle resource collision between tasks (as shown in FIG. 3), the mobile station determines whether resource collision occurs or not when task 5 begins. Obviously, resource collision occurs between task 5 and task 6 (i.e. execution intervals of two tasks overlap). Then, the mobile station determines whether task 5 has higher priority than task 6 or not (as in step 320). However, task 5 for mobile network 0912 has higher priority than task 6 so that task 5 is executed. On the other hand, since the task class of task 6 is paging reception, task 6 is canceled. After one paging cycle of mobile network 0953, the mobile station starts the paging reception (i.e., task 7) for repaging.

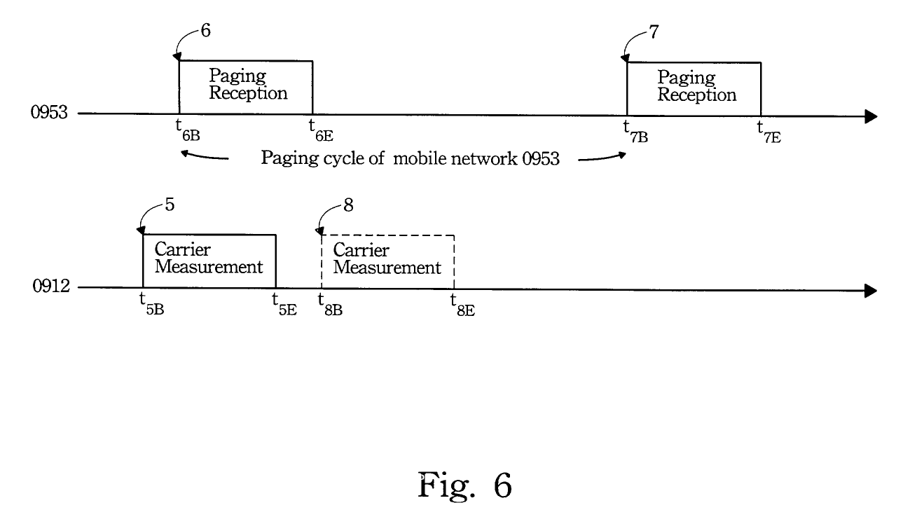

FIG. 6 illustrates one preferred embodiment of the invention according to the mobile network distinction and task classes. In this preferred embodiment of the invention, tasks can be executed according the following priority sequence:

(a) the real time task (e.g., paging reception) of mobile network 0912;

(b) the real time task of mobile network 0953;

(c) the non-real time task of mobile network 0912; and

(d) the non-real time task of mobile network 0953.

As shown in FIG. 6, there are 3 predetermined tasks executed sequentially in this period of time (same as FIG. 5):

Task 5 (t_{5B}, t_{5E}, 0912, carrier measurement)

Task 6 (t_{6B}, t_{6E}, 0953, paging reception)

Task 7 (t_{7B}, t_{7E}, 0953, paging reception)

According to the flowchart illustrating a mobile station system to handle resource collision between tasks (as shown in FIG. 3), the mobile station determines whether resource collision occurs or not (as in step 310) when task 5 begins. Obviously, resource collision occurs between task 5 and task 6 (i.e., execution intervals of two tasks overlap). Then, the mobile station determines whether task 5 has higher priority than task 6 or not (as in step 320). Since paging reception belonging to a real time task has higher priority than carrier measurement so that task 6 is executed. On the other hand, since the task class of task 5 is carrier measurement, task 5 is postponed. After task 6 is finished, the mobile station starts to perform task 8 (i.e., the postponed task 5 for carrier measurement).

The mobile communication system of the present invention decides the priority of tasks, allocates resources to the high-priority task, and delays or cancels low-priority tasks according to the mobile network distinction mainly and according to the task classes subsequently. Furthermore, the mobile station of this invention can simultaneously stand by on multiple mobile networks. The radio transceiver of the mobile station can be used to perform paging reception, location registration, carrier measurement, or broadcast reception for multiple mobile networks to access the mobile network service. In this way the users' requirements for multi-directory mobile phones can be satisfied.

Although the present invention has been described in considerable detail with reference to certain preferred embodiments thereof, other embodiments are possible. For example, present invention is not limited to a mobile station with two SIM cards, two directory numbers or two mobile networks. It can apply to a mobile station with at least one SIM card, at least two directory numbers or at least two mobile networks. Besides, the mobile communication system is not limited to GSM. It can be other different systems such as GSM and GPRS (General Packet Radio Service) or 802.11 WLAN (Wireless Local Area Network) and GPRS. Therefore, the spirit and scope of the appended claims should not be limited to the description of the preferred embodiments contained herein.

What is claimed is:

1. A system for mobile station to handle resource collision between tasks, the system comprising:
a first mobile network;
a second mobile network; and
a mobile station, wherein the mobile station has said first mobile network and said second mobile network simultaneously on standby, performs a first task for said first mobile network and performs a second task for said second mobile network, whereupon a priority task is executed according to mobile network distinction when resource collision occurs between the first task and the second task.

2. The system of claim 1, wherein a non-priority task is canceled or postponed according to mobile network distinction when resource collision occurs between the first task and the second task.

3. The system of claim 1, wherein the priority task is executed according to mobile network distinction and task classes.

4. The system of claim 3, wherein the priority task is executed according to rules of mobile network distinction and task classes as follows:
(a) a real time task of said first mobile network;
(b) a real time task of said second mobile network;
(c) a non-real time task of said first mobile network; and
(d) a non-real time task of said second mobile network;

5. The system of claim 4, wherein the real time task is paging reception and the non-real time task is location registration, carrier measurement or broadcast reception.

6. The system of claim 1, wherein the mobile network distinction is a directory number, a mobile network reference number or SIM card reference number.

7. The system of claim 1, wherein the task is paging reception, location registration, carrier measurement, or broadcast reception.

8. The system of claim 1, wherein said first mobile network and said second mobile network use the same mobile communication system, and the mobile communication system is GSM.

9. The system of claim 1, wherein said first mobile network and said second mobile network use two different mobile communication systems, and said first mobile network is GSM while said second mobile network is GPRS or said first mobile network is GPRS while said second mobile network is WLAN.

10. The system of claim 1, wherein the mobile network distinction can be set automatically by the system or manually by users.

11. A method for mobile station to handle resource collision between tasks, wherein a mobile station having a first mobile network and a second mobile network simultaneously on standby performs a first task for the first mobile network and performs a second task for the second mobile network, and a priority task is executed according to mobile network distinction when resource collision occurs between the first task and the second task.

12. The system of claim 11, wherein a non-priority task is canceled or postponed according to the mobile network distinction when resource collision occurs between the first task and the second task.

13. The system of claim 11, wherein the priority task is executed according to the mobile network distinction and the task classes.

14. The system of claim 13, wherein the priority task is executed according to rules of mobile network distinction and the task classes as follows:
(a) a real time task of the first mobile network;
(b) a real time task of the second mobile network;
(c) a non-real time task of the first mobile network; and
(d) a non-real time task of the second mobile network;

15. The system of claim 14, wherein the real time task is paging reception and the non-real time task is location registration, carrier measurement or broadcast reception.

16. The system of claim 11, wherein the mobile network distinction is a directory number, a mobile network reference number or SIM card reference number.

17. The system of claim 11, wherein the task is paging reception, location registration, carrier measurement, or broadcast reception.

18. The system of claim 11, wherein said first mobile network and said second mobile network use the same mobile communication system, and the mobile communication system is GSM.

19. The system of claim 11, wherein said first mobile network and said second mobile network may two different mobile communication systems, and said first mobile network is GSM while said second mobile network is GPRS or said first mobile network is GPRS while said second mobile network is WLAN.

20. The system of claim 11, wherein the mobile network distinction can be set automatically by the system or manually by users.
